(19) United States
(12) Patent Application Publication
(10) Pub. No.: US 2008/0297057 A1
(43) Pub. Date: Dec. 4, 2008

(54) Plasma display panel and method of driving the same

(76) Inventors: Min Hur, Suwon-si (KR); Jeong-Doo Yi, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/155,334

(22) Filed: Jun. 3, 2008

(30) Foreign Application Priority Data
Jun. 4, 2007 (KR) 10-2007-0054625

(51) Int. Cl. G09G 3/10; H01J 17/49

(52) U.S. Cl. 315/169.4; 313/582

(57) ABSTRACT

A plasma display panel (PDP) includes a first substrate and a second substrate spaced apart and facing each other, first barrier ribs between the first and second substrates to define a plurality of discharge cells, first and second discharge electrodes along a first direction between the first and second substrates, and address electrodes along a second direction between the first and second substrates, the address electrodes including bus portions and discharge portions electrically connected to the bus portions, wherein a distance along the second direction between a discharge portion of an address electrode and an adjacent first discharge electrode is shorter than a distance along the second direction between the discharge portion and an adjacent second discharge electrode.

### BACKGROUND OF THE INVENTION

1. Field of the Invention

Embodiments of the present invention relate to a plasma display panel (PDP). More particularly, embodiments of the present invention relate to a PDP with reduced address discharge firing voltage and high reliability in gradation realization, and a method of driving the same.

2. Description of the Related Art

A plasma display panel (PDP) refers to a display device forming images by using a gas discharge phenomenon. The PDP may exhibit excellent display properties, e.g., improved brightness, enhanced contrast, reduced latent images, increased viewing angles, and so forth, and improved structural characteristics, e.g., large and thin screens.

A conventional PDP, e.g., a three-electrode surface discharge type PDP, may include barrier ribs between first and second substrates to define a plurality of discharge cells. The conventional PDP may further include a plurality of discharge electrodes on the first substrate facing the barrier ribs, and a dielectric layer between the discharge electrodes and the barrier ribs. Application of voltage to the discharge cells may generate discharge therein, so light may be emitted from the discharge cells to form images. The discharge electrodes, however, may have a narrow discharge gap therebetween, thereby reducing light emitting efficiency. Further, the discharge in the discharge cells may be generated in regions located in close proximity to the dielectric layer, thereby decreasing discharge uniformity in the discharge cells, which in turn, may further reduce light emitting efficiency.

### SUMMARY OF THE INVENTION

Embodiments of the present invention are therefore directed to a plasma display panel (PDP) and a method of driving the same, which substantially overcome one or more of the disadvantages and shortcomings of the related art.

It is therefore a feature of an embodiment of the present invention to provide a PDP having an electrode structure capable of improving light emitting efficiency and reducing address discharge firing voltage thereof.

It is therefore another feature of an embodiment of the present invention to provide a PDP having electrode and barrier rib structures capable of improving visible light transmittivity and reliability for gradation realization therein.

It is yet another feature of an embodiment of the present invention to provide a method of driving a PDP having one or more of the above features.

At least one of the above and other features and advantages of the present invention may be realized by providing a PDP, including a first substrate and a second substrate spaced apart and facing each other, first barrier ribs between the first and second substrates to define a plurality of discharge cells, first and second discharge electrodes along a first direction between the first and second substrates, and address electrodes along a second direction between the first and second substrates, the address electrodes including bus portions and discharge portions electrically connected to the bus portions, wherein a distance along the second direction between a discharge portion of an address electrode and an adjacent first discharge electrode may be shorter than a distance along the second direction between the discharge portion and an adjacent second discharge electrode.

The first barrier ribs may include vertical barrier ribs along the first direction and horizontal barrier ribs along the second directions, the first and second discharge electrodes being positioned inside the vertical barrier ribs. The vertical barrier ribs may include first and second vertical barrier rib portions in an alternating pattern, the first discharge electrodes being inside the first vertical barrier rib portions and the second discharge electrodes being inside the second vertical barrier rib portions. A thickness of the first vertical barrier rib portions as measured along the second direction from an outer surface of the first discharge electrode to an immediately adjacent outer surface of the first vertical barrier rib portion may be greater than a thickness of the second vertical barrier rib portions as measured along the second direction from an outer surface of the second discharge electrode to an immediately adjacent outer surface of the second vertical barrier rib portion. The first and second discharge electrodes may include volumetric portions connected by connection portions, the volumetric portions being positioned to correspond to centers of respective discharge cells and the connection portions being positioned to correspond to intersection points of vertical and horizontal barrier ribs. The volumetric portions of the first discharge electrodes may be shorter than the volumetric portions of the second discharge electrodes along the first direction. The volumetric portions may be wider than the connection portions along the second direction. The volumetric portions may be higher than the connection portions along a third direction, the third direction being perpendicular to a plane formed by the first and second directions.

The bus portions may be between the first barrier ribs and the first substrate. The first barrier ribs may include horizontal barrier rib portions substantially parallel to the bus portions, the bus portions being between the horizontal barrier rib portions and the first substrate. The horizontal barrier rib portions may be wider than the bus portions along the first direction. The bus portions may completely overlap with the horizontal barrier rib portions. The discharge portions may include one edge connected to the bus portion and another edge extending toward respective centers of the discharge cells. Each of the address electrodes may include one bus portion and a plurality of discharge portions, each of the discharge portions corresponding to a respective discharge cell. The bus portions may include a conductive metal. The discharge portions may include a transparent material. The PDP may further include a dielectric layer on the address electrodes. The address electrodes may be on the first substrate facing the second substrate. The PDP may further include second barrier ribs between the second substrate and the first barrier ribs, and phosphor layers on sidewalls of the second barrier ribs.

At least one of the above and other features and advantages of the present invention may be also realized by providing a method of driving a plasma display panel having first and second substrates spaced apart and facing each other, first barrier ribs between the first and second substrates to define a plurality of discharge cells, first and second discharge electrodes along a first direction between the first and second substrates, and address electrodes along a second direction between the first and second substrates, the address electrodes including bus portions and discharge portions electrically connected to the bus portions, wherein a distance along the second direction between a discharge portion of an address electrode and an adjacent first discharge electrode may be shorter than a distance along the second direction between the discharge portion and an adjacent second discharge electrode, the method including generating an odd-numbered address discharge in only odd-numbered rows of the discharge cells, and generating an even-numbered address discharge in only even-numbered rows of the discharge cells to select discharge cells, and applying first and second voltage pulses to the first and second discharge electrodes, respectively, of the selected discharge cells during a sustain discharge, wherein a magnitude of the first voltage pulse may be smaller than a magnitude of the second voltage pulse.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partially exploded perspective view of a plasma display panel (PDP) according to an embodiment of the present invention;

FIG. 2 illustrates an assembled cross-sectional view along line III-III of FIG. 1;

FIG. 3 illustrates a plan view of the PDP of FIG. 1 as seen without a first substrate;

FIG. 4 illustrates a graph of discharge current through scan and sustain electrodes, i.e., Y and X electrodes, of the PDP of FIG. 1;

FIG. 5A-5B illustrate ultraviolet (UV) light emission distribution with respect to time of the scan and sustain electrodes, i.e., Y and X electrodes, respectively, of the PDP of FIG. 1;

FIG. 6 illustrates a partially exploded perspective view of a PDP according to another embodiment of the present invention;

FIG. 7 illustrates an assembled partial cross-sectional view along line VIII-VIII of FIG. 6;

FIG. 8 illustrates a partially exploded perspective view of a PDP according to another embodiment of the present invention;

FIG. 9 illustrates an assembled partial cross-sectional view along line X-X of FIG. 8; and

FIG. 10 illustrates a timing diagram of a driving method of a PDP according to another embodiment of the present invention.

### DETAILED DESCRIPTION OF THE INVENTION

Korean Patent Application No. 10-2007-0054625, filed on Jun. 4, 2007, in the Korean Intellectual Property Office, and entitled: “Plasma Display Panel and Method of Driving the Same,” is incorporated by reference herein in its entirety.

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer, element, or substrate, or intervening layers or substrates may also be present. In addition, it will also be understood that when a layer or element is referred to as being “between” two layers or elements, it can be the only layer or element between the two layers or elements, or one or more intervening layers or elements may also be present. Like reference numerals refer to like elements throughout.

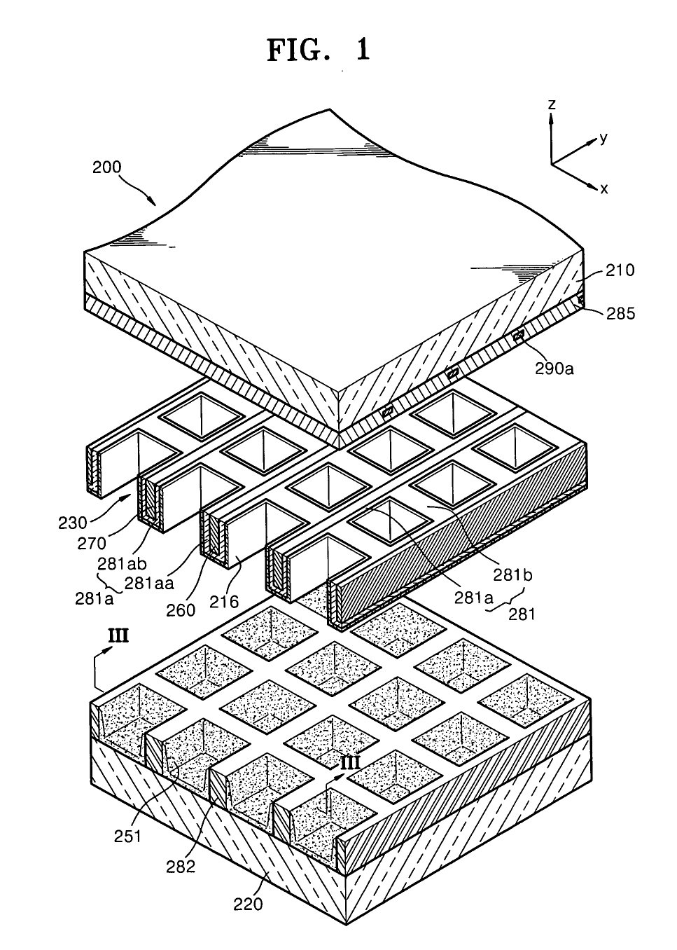

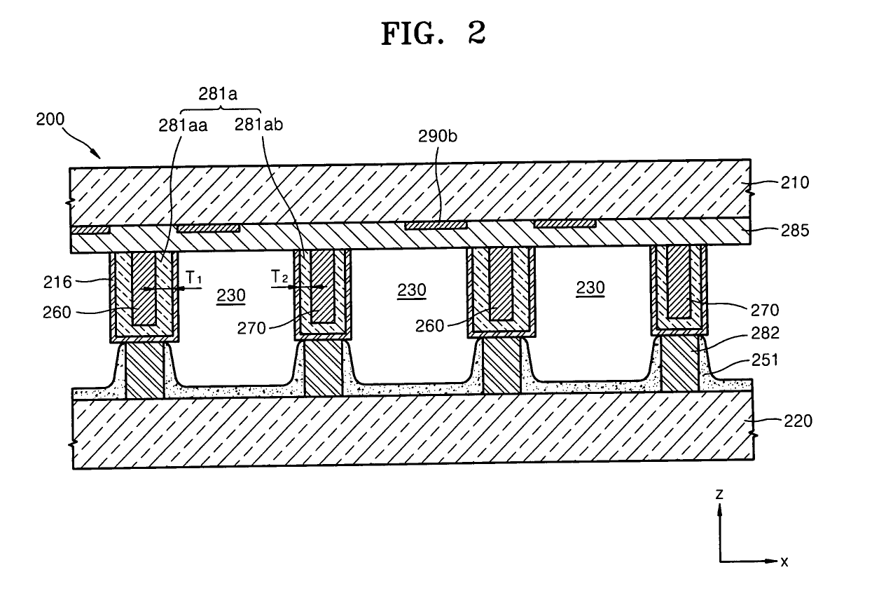

A plasma display panel (PDP) 200 according to an embodiment of the present invention will be described in more detail below with reference to FIGS. 1-5B. As illustrated in FIGS. 1-2, the PDP 200 may include first and second substrates 210 and 220, first barrier ribs 281 between the first and second substrates 210 and 220 to define a plurality of discharge cells 230, a plurality of first and second discharge electrodes 260 and 270 between the first and second substrates 210 and 220, a plurality of address electrodes 290 between the first and second substrates 210 and 220, second barrier ribs 282, and a photoluminescent material 251 in the discharge cells 230.

The first and second substrates 210 and 220 may face each other, and may be spaced apart from each other. The first and second substrates 210 and 220 may be formed of any suitable material, e.g., a light transmitting material, and may be processed to reduce reflection brightness in order to improve bright room contrast. For example, the first substrate 210 may be formed of glass, and may be colored to reduce reflection brightness. In another example, one or more of the first substrate 210 and/or the second substrate 220 may be formed of glass and/or may be colored. The first and second substrates 210 and 220 may be bonded to each other, e.g., by applying frit glass between edges thereof, to enclose the discharge cells 230 in a space between the first and second substrates 210 and 220. Once the discharge cells 230 are enclosed between the first and second substrates 210 and 220, a discharge gas, e.g., neon (Ne), xenon (Xe), or a mixture thereof, may be filled in the discharge cells 230.

The first barrier ribs 281 of the PDP 200 may be arranged between the first and second substrate 210 and 220. The first barrier ribs 281 may be arranged to define the discharge cells 230 to have any suitable cross-section, e.g., triangular, quadrangular, pentagonal, circular, oval, and so forth. For example, as illustrated in FIG. 1, the discharge cells 230 may have a rectangular cross-section. The first barrier ribs 281 may include vertical barrier ribs 281a along a first direction, e.g., along the y-axis, and horizontal barrier ribs 281b along a second direction, e.g., along the x-axis. The first barrier ribs 281 may be formed of any suitable dielectric material, and may accumulate wall charges by inducing charges.

The vertical barrier ribs 281a of the first barrier ribs 281 may include first and second vertical barrier rib portions 281aa and 281ab, as illustrated in FIGS. 1-2. In particular, the first and second vertical barrier rib portions 281aa and 281ab may extend along the first direction, and may be arranged in alternating pattern, e.g., a first vertical barrier rib portion 281aa may be positioned between two second vertical barrier rib portions 281ab. Accordingly, one first vertical barrier rib portion 281aa and an adjacent second vertical barrier rib portion 281ab may define an array of discharge cells 230 therebetween, e.g., a column of discharge cells 230 along the first direction.

The plurality of first and second discharge electrodes 260 and 270 of the PDP 200 may be scan and sustain electrodes, respectively. A reverse configuration, i.e., the first and second discharge electrodes 260 and 270 being sustain and scan electrodes is also within the scope of the present invention. The first and second discharge electrodes 260 and 270 may be arranged inside, i.e., within, the vertical barrier ribs 281a of the first barrier ribs 281. The first and second discharge electrodes 260 and 270 may be arranged in an alternating stripe pattern, so that one first discharge electrode 260 may be positioned inside one vertical barrier rib portion 281a and one second discharge electrode 270 may be positioned inside an adjacent vertical barrier rib portion 281a. For example, the first discharge electrodes 260 may be positioned inside the first vertical barrier rib portions 281aa, and the second discharge electrodes 270 may be positioned inside the second vertical barrier rib portions 281ab. The first and second discharge electrodes 260 and 270 may be positioned inside the first and second vertical barrier rib portions 281aa and 281ab, respectively, so a thickness T1 of the first vertical barrier rib portion 281aa may be larger than a thickness T2 of the second vertical barrier rib portion 281ab, as illustrated in FIG. 2. In this respect, it is noted that the thickness T1 refers to a thickness, i.e., a distance along the x-axis, of the first vertical barrier rib portion 281aa on one surface of the first discharge electrode 260, i.e., a distance between an outer surface of the first discharge electrode 260 and an immediately adjacent outer surface of the first vertical barrier rib portion 281aa. Similarly, the thickness T2 refers to a thickness, i.e., a distance along the x-axis, of the second vertical barrier rib portion 281ab on one surface of the second discharge electrode 270, i.e., a distance between an outer surface of the second discharge electrode 270 and an immediately adjacent outer surface of the second vertical barrier rib portion 281ab.

As such, an array of discharge cells 230 may be arranged between adjacent first and second discharge electrodes 260 and 270 along the first direction, e.g., the y-axis. The first and second discharge electrodes 260 and 270 may be parallel to each other, and may generate discharge in the discharge cells 230 therebetween. Since the first and second discharge electrodes 260 and 270 may be arranged in an alternating stripe pattern, discharge may be generated in discharge cells 230 arranged on both sides of a single vertical barrier rib 281a. Since the first and second discharge electrodes 260 and 270 are inside different vertical barrier ribs 281a, i.e., the first and second discharge electrodes 260 and 270 may not be formed on one vertical barrier rib 281, a width of the vertical barrier rib 281a along the x-axis may be reduced.

Formation of the first and second discharge electrodes 260 and 270 inside the first barrier ribs 281 may be advantageous in preventing or substantially minimizing overlap of opaque elements with the discharge cells 230 and, thereby, improve visible light transmittivity. Accordingly, the first and second discharge electrodes 260 and 270 may be formed of a conductive metal, e.g., aluminum, copper, and so forth. Use of the conductive metal may generate only a small voltage decrease and, thereby, facilitate stable signal transmission between the first and second discharge electrodes 260 and 270. In addition, formation of the first and second discharge electrodes 260 and 270 inside the first barrier ribs 281 may prevent electrical contact between the first and second discharge electrodes 260 and 270, and may prevent damage to the first and second discharge electrodes 260 and 270 from charged particles during discharge. Further, formation of the first and second discharge electrodes 260 and 270 inside the first barrier ribs 281 may increase a distance between the first and second discharge electrodes 260 and 270 and, thereby, generate a longer discharge gap therebetween. The increased discharge gap may increase ultraviolet density in the positive column, so the discharge efficiency of the PDP 200 may be substantially increased.

The address electrodes 290 of the PDP 200 may be positioned along the second direction, e.g., along the x-axis, on the first substrate 210 to face the discharge cells 230, and may be spaced apart from each other. Each of the address electrodes 290 may be positioned along an array of discharge cells 230, and may include a bus portion 290a along the array of discharge cells 230, i.e., crossing the first and second discharge electrodes 260 and 270, and a plurality of discharge portions 290b on the bus portion 290a. A dielectric layer 285 may be formed between the first barrier ribs 281 and the first substrate 210 to cover the address electrodes 290.

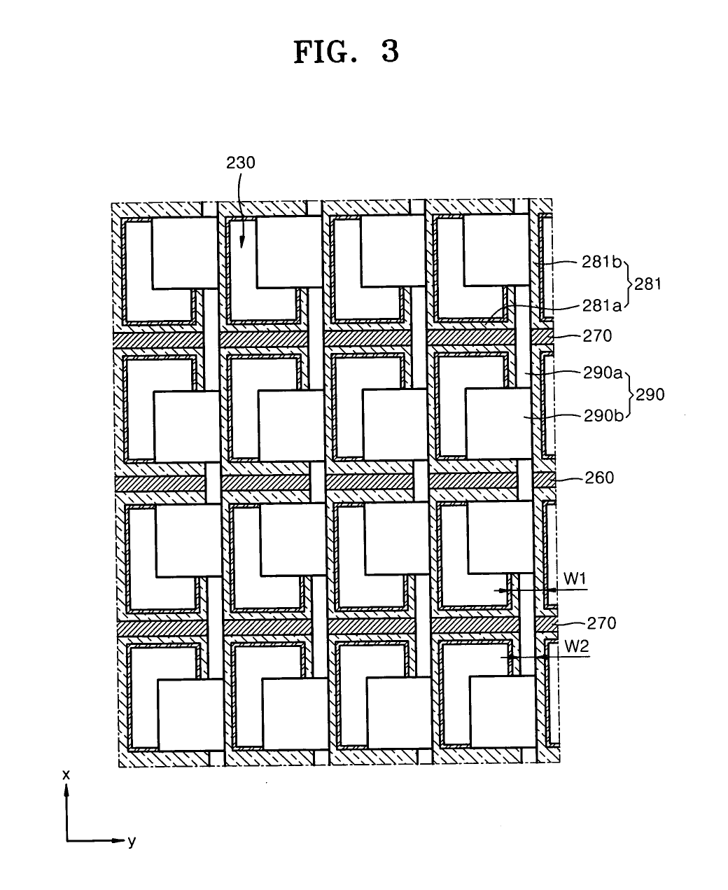

The bus portions 290a may be arranged in a stripe pattern, and may be positioned between the first barrier ribs 281 and the first substrate 210, as illustrated in FIG. 1. The bus portions 290a may have a width W2, and may completely overlap with the horizontal barrier rib portions 281b having a width W1, as illustrated in FIG. 3. The complete overlap of the bus portions 290a with the horizontal barrier rib portions 281b may prevent an overlap of the bus portions 290a with the discharge cells 230, thereby substantially increasing visible light transmittivity through the PDP 200. Accordingly, the bus portions 290a may be formed of a conductive metal, e.g., aluminum, copper, and so forth.

The discharge portions 290b of one address electrode 290 may have any suitable geometrical shape, e.g., a quadrangle, and may be formed of a transparent material, e.g., indium-titanium-oxide (ITO). The discharge portions 290b may be electrically connected to a respective bus portion 290a, and may correspond to a respective discharge cell 230. Accordingly, each discharge portion 290b may be connected to the bus portion 290a at one end, and may extend toward a center of the respective discharge cell 230. For example, as illustrated in FIG. 3, each discharge portion 290b may have a rectangular shape, and may be positioned to overlap a corner of the respective discharge cell 230. More specifically, as illustrated in the exemplary configuration of FIG. 3, each discharge portion 290b may be positioned to have a first edge thereof in close proximity and parallel to an edge of the first discharge electrode 260, and may have a second edge of the discharge portion 290b, i.e., an edge perpendicular to the first edge, along an edge of the bus portion 290a.

In particular, as illustrated in FIGS. 2-3, the discharge portions 290b may be arranged closer to the first discharge electrodes 260 than to the second discharge electrodes 270. In other words, a distance along the x-axis between the discharge portions 290b and an adjacent first discharge electrodes 260 may be shorter than a distance along the x-axis between the discharge portions 290b and an adjacent second discharge electrodes 270. Accordingly, when the first and second discharge electrodes 260 and 270 are used as, e.g., scan and sustain electrodes, respectively, a firing voltage for an address discharge between the address electrodes 290 and the first discharge electrodes 260 may be substantially reduced. The reduced firing voltage for an address discharge may facilitate a sustain discharge between the first and second discharge electrodes 260 and 270, i.e., reduce voltage at which a sustain discharge may be initiated.

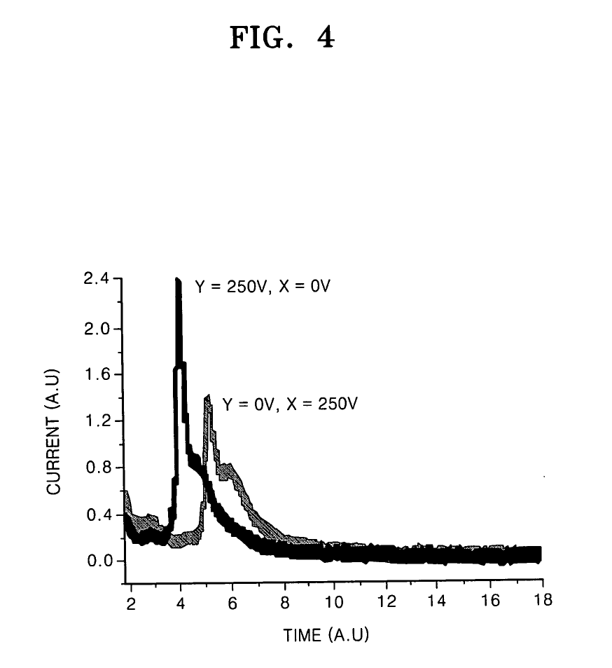

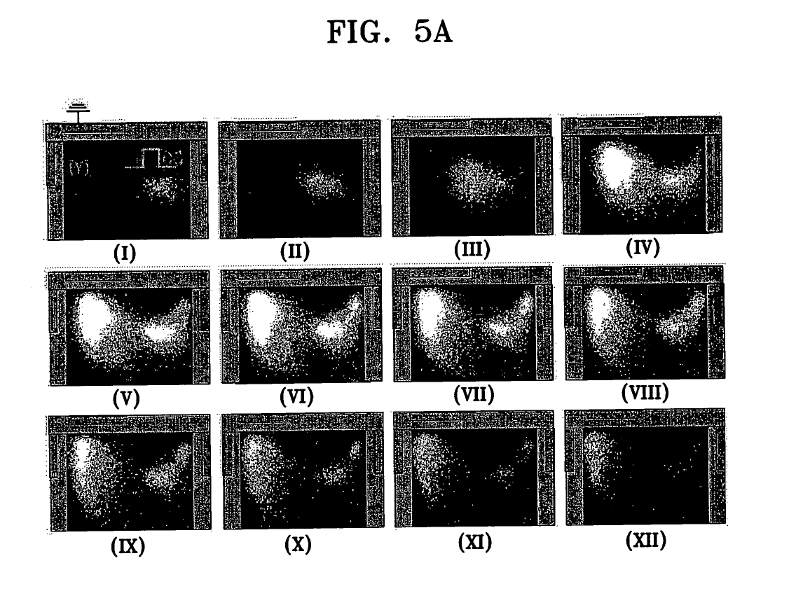

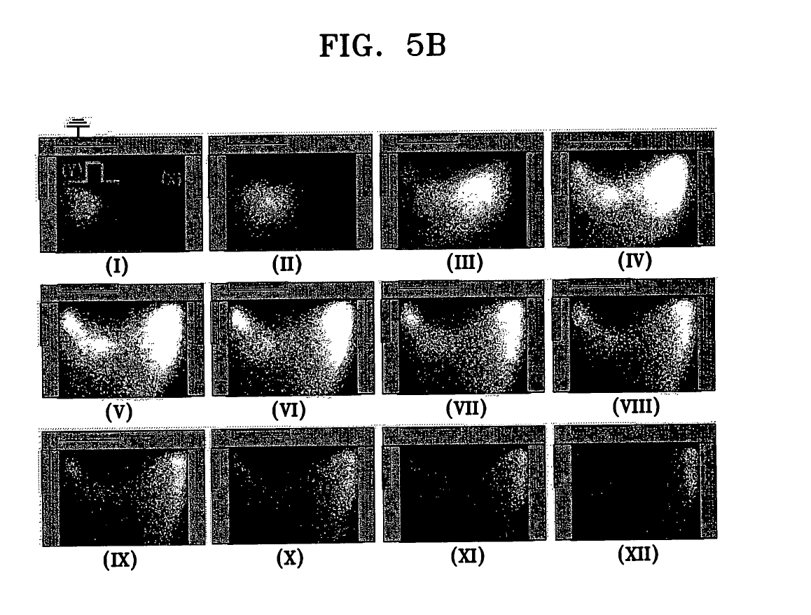

The structure of the address electrodes 290 and the first and second discharge electrodes 260 and 270 of the PDP 200 may provide the following discharge firing voltage relationship therebetween, V_{XY}>V_{XA}>V_{YA}, wherein A refers to the address electrodes 290, and Y and X refer to the first and second discharge electrodes 260 and 270, respectively. For example, as illustrated in FIG. 4, when a sustain voltage pulse of 250 V is applied constantly to the first discharge electrodes 260, the discharge delay may be shorter and the discharge current may be greater, as compared to constant application of a sustain voltage pulse of 250 V to the second discharge electrodes 270. In other words, when a pulse is applied to the first discharge electrodes 260, the discharge cells 230 may be driven at a relatively lower voltage. An increased current discharge through the first discharge electrode 260 may cause stronger ultraviolet light emission around the first discharge electrodes 260. In particular, as illustrated in FIGS. 5A-5B, when a constant and substantially same sustain voltage pulse is applied to the first and second electrodes 260 and 270 during a sustain discharge, ultraviolet light emission generation with respect to time may be substantially larger around the first discharge electrode 260 than around the second discharge electrodes 270.

However, the different thicknesses T1 and T2 of the first and second vertical barrier rib portions 281aa and 281ab, respectively, may prevent or substantially minimize any potential non-uniform light emission in the PDP 200. In particular, thickness adjustment, i.e., thicker first vertical barrier rib portions 281aa around the first discharge electrodes 260, may adjust the larger amount of ultraviolet light generated by the first discharge electrode 260. Accordingly, an amount of light emitted from all the discharge cells 230 may be uniform when a constant pulse is applied to the first and second discharge electrodes 260 and 270 of the PDP 200 and, thereby, provide high reliability of gradation realization.

The second barrier ribs 282 of the PDP 200 may be between the second substrate 220 and the first barrier ribs 281. As illustrated in FIGS. 1-2, the first barrier ribs 281 may be on the second barrier ribs 282 to facilitate definition of discharge cells 230. In other words, the first barrier ribs 281 may define an upper portion of the discharge cells 230, and the second barrier ribs 282 may define a lower portion of the discharge cells 230, as illustrated in FIG. 2. Alternatively, the second barrier ribs 282 may be positioned between the first dielectric layer 285 and the first barrier ribs 281 (not shown), so the first barrier ribs 281 may define a lower portion of the discharge cells 230, and the second barrier ribs 282 may define an upper portion of the discharge cells 230. The second barrier ribs 282 may be arranged to have a closed structure, e.g., a matrix cross section, that may be substantially same as a cross section of the first barrier ribs 281, or to have an open structure, e.g., a stripe pattern, in order to improve discharge performance.

The photoluminescent material 251 of the PDP 200 may be deposited in the discharge cells 230. For example, as illustrated in FIGS. 1-2, the photoluminescent material may be deposited on the second barrier ribs 282 and on the second substrate 220. The photoluminescent material 251, e.g., phosphor layers, may emit light generated by ultraviolet light. For example, the photoluminescent material 251 may include red light emitting phosphor layers, e.g., Y(V,P)O₄:Eu, and so forth, green light emitting phosphor layers, e.g., Zn₂SiO₄:Mn, YBO₃:Tb, and so forth, and/or blue light emitting phosphor layers, e.g., BAM:Eu, and so forth. An increased surface area of the photoluminescent material 251 may increase an amount of emitted light, so use of the second barrier ribs 282 in addition to the first barrier ribs 281 may increase a coating surface area of the photoluminescent material 251 and, thereby, improve brightness and light emitting efficiency of the PDP 200.

The PDP 200 may further include a protection layer 216 on the first barrier ribs 281. The protection layer 216 may prevent or substantially minimize contact between plasma particles and the first barrier ribs 281, thereby minimizing damage to the first barrier ribs 281. Also, the protection layer 216 may emit secondary electrons to reduce the discharge voltage. The protection layer 216 may be formed by depositing, e.g., magnesium oxide (MgO), on the first barrier ribs 281. For example, the protection layer 216 may be on side surfaces and on an outer bottom surface of the first barrier ribs 281, so the first barrier ribs 281 may be between the discharge electrodes and the protection layer 216, as illustrated in FIGS. 1-2.

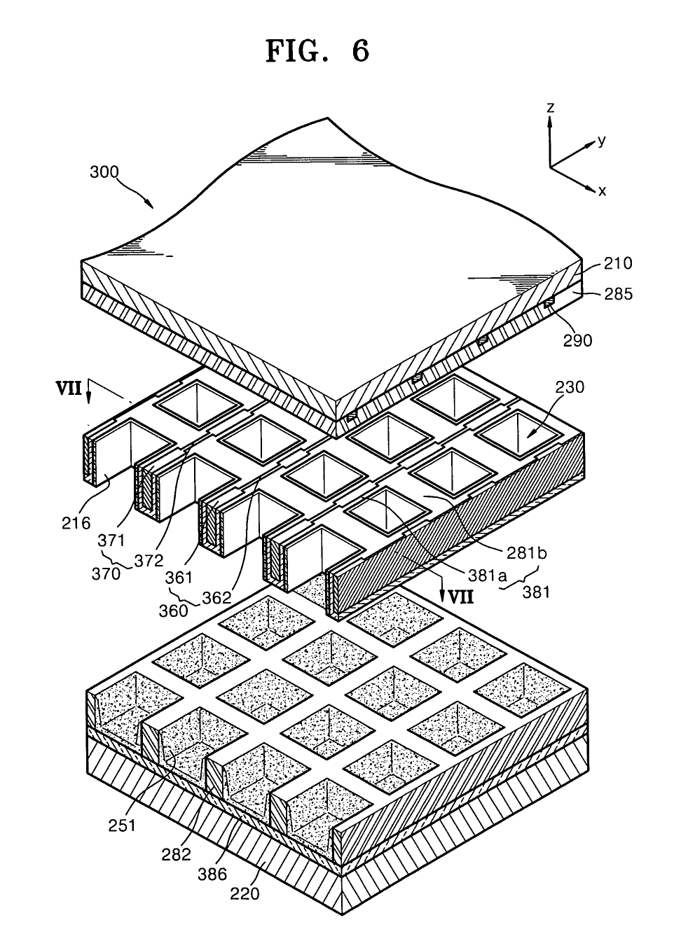

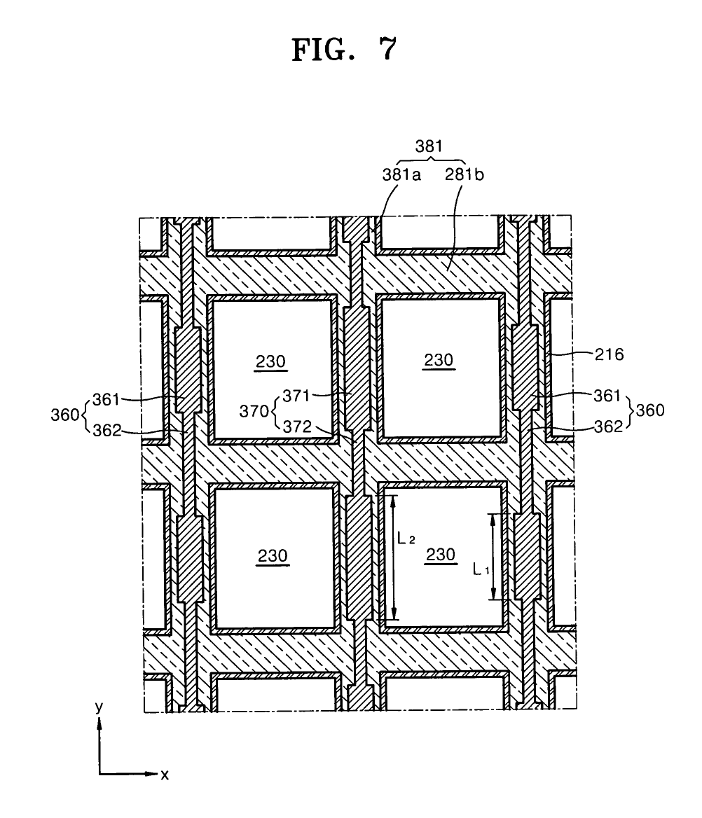

According to another embodiment illustrated in FIGS. 6-7, a PDP 300 may be substantially similar to the PDP 200 described previously with respect to FIGS. 1-5B, with the exception of having a light reflection layer 386 and different structures of the first and second discharge electrodes 360 and 370.

The light reflection layer 386 of the PDP 300 may be positioned between the second substrate 220 and the second barrier ribs 282 to prevent or substantially minimize light transmittance through the second substrate 220. More specifically, light generated in the discharge cells 230 may be reflected from the light reflection layer 386 toward the first substrate 210, so the generated light may not project outside via the second substrate 220. The light reflection layer 386 may be formed of, e.g., a white dielectric material.

The first and second discharge electrodes 360 and 370 of the PDP 300 may be substantially similar to the first and second discharge electrodes 260 and 270 of the PDP 200, with the exception of having a plurality of volumetric portions, e.g., protrusions, and connection portions instead of a substantially uniform linear structure. For example, the first discharge electrodes 360 may be arranged inside the vertical barrier ribs 281a of the first barrier ribs 281, and may include a plurality of first protrusions 361 and first connection portions 362 connected to each other, as illustrated in FIGS. 6-7. In particular, the first protrusions 361 may extend along the y-axis between the first connection portions 362, so each first protrusion 361 may be between and connected to two first connection portions 362. The first protrusions 361 may be wider than the first connection portions 362 as measured along the x-axis, so the first protrusions 361 may protrude toward the discharge cells 230.

For example, as illustrated in FIGS. 6-7, the first connection portions 362 may be centered along the x-axis with respect to the first protrusions 361, so the first protrusions 361 may protrude toward the discharge cells 230 on each side thereof. The first protrusions 361 and the first connection portions 362 may alternate along the y-axis, so the first protrusions 361 may be positioned to correspond to centers of the discharge cells 330 and the first connection portions 362 may be positioned to correspond to intersection points of horizontal barrier ribs 281b with the vertical barrier ribs 281a. The first connection portions 362 may be sufficiently long to extend along edges of the discharge cells 230.

The second discharge electrodes 370 may include second protrusions 371 and second connection portions 372 connecting the second protrusions 371. The second discharge electrodes 370 may be substantially similar to the first discharge electrodes 360, with the exception that a length L1 of the first protrusions 361, i.e., a distance as measured along the y-axis, may be shorter than a length L2 of the second protrusions 371. Accordingly, a surface area of the first protrusions 361 may be smaller than a surface area of the second protrusions 371 and, thereby, form first discharge electrodes with a smaller surface area than the a surface area of the second discharge electrodes 370.

Accordingly, the different surface areas of the first and second protrusions 361 and 362, i.e., due to the different lengths L1 and L2 thereof, may prevent or substantially minimize any potential non-uniform light emission in the PDP 300. In particular, smaller surface areas of the first protrusions 361 of the first discharge electrodes 360 may adjust the larger amount of ultraviolet light generated by the first discharge electrode 360. Accordingly, an amount of light emitted from all the discharge cells 230 may be uniform when a constant pulse is applied to the first and second discharge electrodes 360 and 370 and, thereby, provide high reliability of gradation realization. In this respect, it is noted that the thicknesses T1 and T2 of the first and second vertical barrier rib portions 281aa and 281ab, respectively, may be different or may be the same. Accordingly, the thickness T1 and T2 and the lengths L1 and L2 may be adjusted with respect to each other to prevent or substantially minimize any potential non-uniform light emission in the PDP 300.

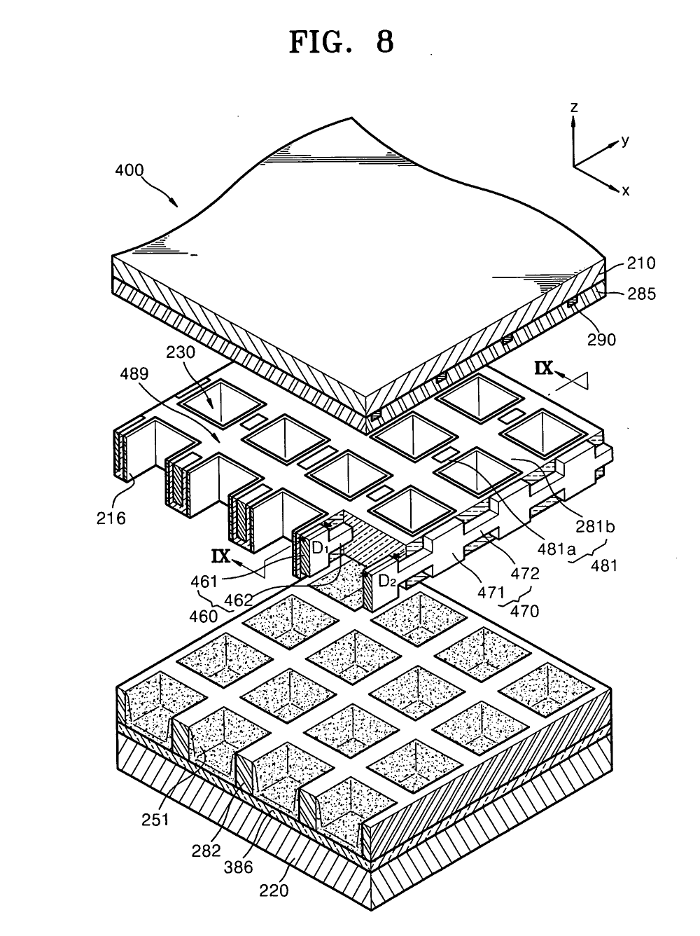

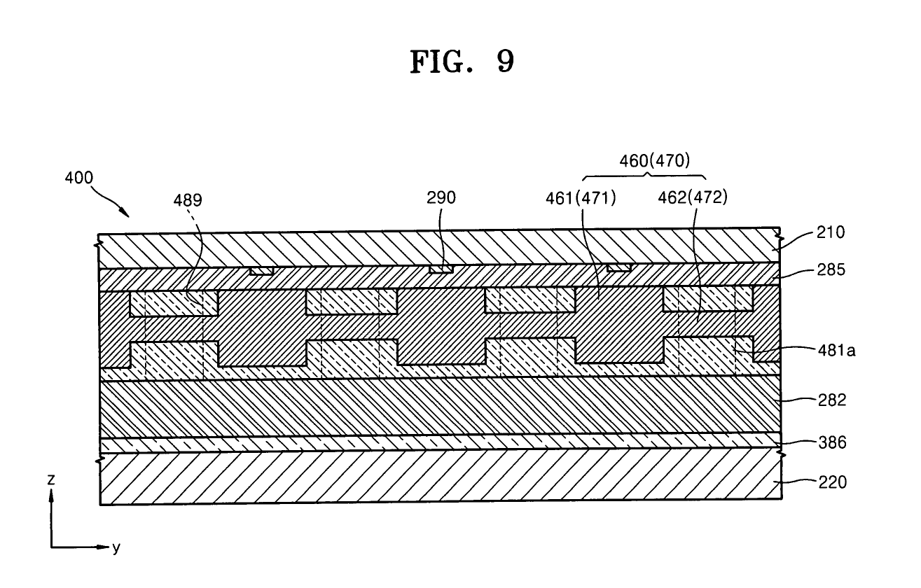

According to another embodiment illustrated in FIGS. 8-9, a PDP 400 may be substantially similar to the PDP 300 described previously with respect to FIGS. 6-7, with the exception of having different structures of first and second discharge electrodes 460 and 470. More specifically, the first and second discharge electrodes 460 and 470 of the PDP 400 may be substantially similar to the first and second discharge electrodes 360 and 370 of the PDP 300, with the exception of having different structures of the volumetric portions and connection portions.

The first discharge electrodes 460 may include first expansions 461 and first connection portions 462 connected to each other, as illustrated in FIGS. 8-9. In particular, the first expansions 461 may extend along the y-axis between the first connection portions 462, so each first expansion 461 may be between and connected to two first connection portions 462. The first expansions 461 may be higher than the first connection portions 462 as measured along the z-axis, so the first expansions 461 may extend to contact directly the dielectric layer 285, as illustrated in FIG. 9. The first connection portions 462 may be as wide as the first expansions 461 along the x-axis. The first expansions 461 may be positioned to correspond to centers of the discharge cells 230 and the first connection portions 462 may be positioned to correspond to intersection points 489 of the vertical and horizontal barrier rib portions 281a and 281b. The first connection portions 462 may be sufficiently long to extend along edges of the discharge cells 230.

The second discharge electrodes 470 may include second expansions 471 and second connection portions 472 connecting the second expansions 471. The second discharge electrodes 470 may be substantially similar to the first discharge electrodes 460, with the exception that a length D1 of the first expansions 461, i.e., a distance as measured along the y-axis, may be shorter than a length D2 of the second expansions 471. In other words, a surface area of the first expansions 461 extending along and facing the discharge cells 230 may be smaller than a surface area of the second expansions 471 extending along and facing the discharge cells 230.

Accordingly, the different surface areas of the first and second expansions 461 and 471, i.e., due to the different lengths D1 and D2 thereof, may prevent or substantially minimize any potential non-uniform light emission in the PDP 400. In particular, smaller surface areas of the first expansions 461 of the first discharge electrodes 460 may adjust the larger amount of ultraviolet light generated by the first discharge electrode 460. Accordingly, an amount of light emitted from all the discharge cells 230 may be uniform when a constant pulse is applied to the first and second discharge electrodes 460 and 470 and, thereby, provide high reliability of gradation realization. In this respect, it is noted that the thicknesses T1 and T2 of the first and second vertical barrier rib portions 281aa and 281ab, respectively, may be different or may be the same. Accordingly, the thickness T1 and T2 and the lengths D1 and D2 may be adjusted with respect to each other to prevent or substantially minimize any potential non-uniform light emission in the PDP 400.

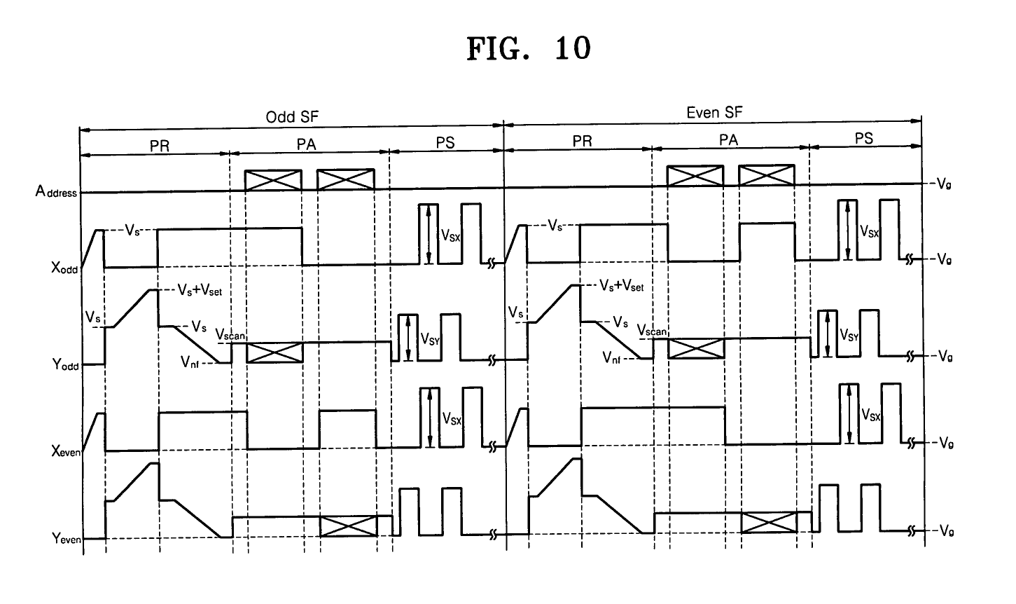

According to another embodiment of the present invention, a PDP may be substantially similar to the PDPs 200, 300, and/or 400, with the exception of having substantially same first and second vertical barrier rib portions, i.e., substantially same thicknesses surrounding respective electrodes, substantially same first and second discharge electrodes, i.e., substantially same surface areas thereof, and different voltage pulses applied to the first and second discharge electrodes. In particular, the PDP may include an alternate lightning of surface (ALiS) driving method, and may include application of a greater amount of a voltage pulse to second discharge electrodes X than to first discharge electrodes Y during a sustain discharge operation. Accordingly, the different voltage pulses may adjust the larger amount of ultraviolet light generated by the first discharge electrode Y, so an amount of light emitted from all the discharge cells may be uniform, i.e., linear, to provide high reliability of gradation realization. The driving method will be described in more detail below with reference to a timing diagram in FIG. 10.

Referring to FIG. 10, a unit frame for driving the PDP may be divided into a plurality of sub-fields for time-sequential gradation display, and reset, address, and sustain discharges may be generated in each of the sub-fields. The plurality of sub-fields may include a plurality of odd-numbered sub-fields OddSF and a plurality of even-numbered sub-fields EvenSF. In the OddSF, a sustain discharge may be generated between odd-numbered X electrodes Xodd and odd-numbered Y electrodes Yodd, and between even-numbered X electrodes Xeven and even-numbered Y electrodes Yeven. In the EvenSF, a sustain discharge may be generated between the odd-numbered Y electrodes Yodd and the even-numbered X electrodes Xeven, and between the even-numbered Y electrodes Yeven and the odd-numbered X electrodes Xodd. A reset period PR, an address period PA, and a sustain period PS may be separated, e.g., as in an address display separated (ADS) method.

With respect to the address period PA of the OddSF and EvenSF, waveforms of voltage applied to the Y electrodes and the address electrodes may be substantially the same, and the address period PA may be divided into OddSF and EvenSF by voltage of the X electrodes. For example, with respect to the address period PA of the OddSF, when applying a voltage to the odd-numbered Y electrodes Yodd and to the address electrodes for selecting discharge cells, i.e., cells to be operated via generation of sustain discharge, a high voltage may be applied to the odd-numbered X electrodes Xodd, and a low voltage may be applied to the even-numbered X electrodes Xeven. Accordingly, address discharge may be generated in the discharge cells between the odd-numbered X electrodes Xodd and the odd-numbered Y electrodes Yodd, but no address discharge may be generated in the discharge cells between the odd-numbered Y electrodes Yodd and the even-numbered X electrodes Xeven. Likewise, with respect to the address period PA of the EvenSF, when applying a voltage to the odd-numbered Y electrodes Yodd and the address electrodes for selecting discharge cells, a low voltage may be applied to the odd-numbered X electrodes Xodd, and a high voltage may be applied to the even-numbered X electrodes Xeven. Accordingly, no address discharge may be generated in the discharge cells between the odd-numbered X electrodes Xodd and odd-numbered Y electrodes Yodd, and an address discharge may be generated in the discharge cells between the odd-numbered Y electrodes Yodd and the even-numbered X electrodes Xeven.

With respect to a sustaining period PS of the OddSF and the EvenSF, an amount of a voltage pulse Vsx applied to the X electrodes may be greater than an amount of a voltage pulse Vsy applied to the Y electrodes. Accordingly, the different voltage pulses may adjust the larger amount of ultraviolet light generated by the first discharge electrode Y in the PDP, so an amount of light emitted from all of the discharge cells may be uniform, i.e., linear, to maintain reliability of gradation.

PDPs according to embodiments of the present invention may be advantageous in having first and second discharge electrodes with an increased discharge gap therebetween, so the light emitting efficiency may be substantially improved. Further, arrangement of discharge portions of the address electrodes in close proximity to the first discharge electrodes may reduce the address discharge firing voltage and, thereby, facilitating sustain discharge between the first and second discharge electrodes. In addition, reliability of gradation realization may be secured by providing different thicknesses of dielectric layers, i.e., barrier ribs, surrounding the first and second discharge electrodes and/or by providing different surface areas of portions of the first and second discharge electrodes oriented toward the inside of the discharge cells. Also, according to the method of driving the PDP, reliability of gradation realization may be secured by applying different voltage pulses to the first and second discharge electrodes in the sustain discharge operation.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a first substrate and a second substrate spaced apart and facing each other;
first barrier ribs between the first and second substrates to define a plurality of discharge cells;
first and second discharge electrodes along a first direction between the first and second substrates; and
address electrodes along a second direction between the first and second substrates, the address electrodes including bus portions and discharge portions electrically connected to the bus portions,
wherein a distance along the second direction between a discharge portion of an address electrode and an adjacent first discharge electrode is shorter than a distance along the second direction between the discharge portion and an adjacent second discharge electrode.

2. The PDP as claimed in claim 1, wherein the first barrier ribs include vertical barrier ribs along the first direction and horizontal barrier ribs along the second direction, the first and second discharge electrodes being positioned inside the vertical barrier ribs.

3. The PDP as claimed in claim 2, wherein the vertical barrier ribs include first and second vertical barrier rib portions in an alternating pattern, the first discharge electrodes being inside the first vertical barrier rib portions and the second discharge electrodes being inside the second vertical barrier rib portions.

4. The PDP as claimed in claim 3, wherein a thickness of the first vertical barrier rib portions as measured along the second direction from an outer surface of the first discharge electrode to an immediately adjacent outer surface of the first vertical barrier rib portion is greater than a thickness of the second vertical barrier rib portions as measured along the second direction from an outer surface of the second discharge electrode to an immediately adjacent outer surface of the second vertical barrier rib portion.

5. The PDP as claimed in claim 2, wherein the first and second discharge electrodes include volumetric portions connected by connection portions, the volumetric portions being positioned to correspond to centers of discharge cells and the connection portions being positioned to correspond to intersection points of vertical and horizontal barrier ribs.

6. The PDP as claimed in claim 5, wherein the volumetric portions of the first discharge electrodes are shorter than the volumetric portions of the second discharge electrodes along the first direction.

7. The PDP as claimed in claim 6, wherein the volumetric portions are wider than the connection portions along the second direction.

8. The PDP as claimed in claim 6, wherein the volumetric portions are higher than the connection portions along a third direction, the third direction being perpendicular to a plane formed by the first and second directions.

9. The PDP as claimed in claim 1, wherein the bus portions are between the first barrier ribs and the first substrate.

10. The PDP as claimed in claim 9, wherein the first barrier ribs include horizontal barrier rib portions substantially parallel to the bus portions, the bus portions being between the horizontal barrier rib portions and the first substrate.

11. The PDP as claimed in claim 10, wherein horizontal barrier rib portions are wider than the bus portions along the first direction.

12. The PDP as claimed in claim 11, wherein the bus portions completely overlap with the horizontal barrier rib portions.

13. The PDP as claimed in claim 9, wherein the discharge portions include one edge connected to the bus portion and another edge extending toward respective centers of the discharge cells.

14. The PDP as claimed in claim 1, wherein each of the address electrodes includes one bus portion and a plurality of discharge portions, each of the discharge portions corresponding to a respective discharge cell.

15. The PDP as claimed in claim 1, wherein the bus portions include a conductive metal.

16. The PDP as claimed in claim 1, wherein the discharge portions include a transparent material.

17. The PDP as claimed in claim 1, further comprising a dielectric layer on the address electrodes.

18. The PDP as claimed in claim 1, wherein the address electrodes are on the first substrate facing the second substrate.

19. The PDP as claimed in claim 1, further comprising:
second barrier ribs between the second substrate and the first barrier ribs; and
phosphor layers on sidewalls of the second barrier ribs.

20. A method of driving a plasma display panel having first and second substrates spaced apart and facing each other, first barrier ribs between the first and second substrates to define a plurality of discharge cells, first and second discharge electrodes along a first direction between the first and second substrates, and address electrodes along a second direction between the first and second substrates, the address electrodes including bus portions and discharge portions electrically connected to the bus portions, wherein a distance along the second direction between a discharge portion of an address electrode and an adjacent first discharge electrode is shorter than a distance along the second direction between the discharge portion and an adjacent second discharge electrode, the method comprising:
generating an odd-numbered address discharge in only odd-numbered rows of the discharge cells, and generating an even-numbered address discharge in only even-numbered rows of the discharge cells to select discharge cells; and
applying first and second voltage pulses to the first and second discharge electrodes, respectively, of the selected discharge cells during a sustain discharge,
wherein a magnitude of the first voltage pulse is smaller than a magnitude of the second voltage pulse.
